(19) United States
(12) Patent Application Publication
(10) Pub. No.: US 2026/0042315 A1
(43) Pub. Date: Feb. 12, 2026

(54) Monoblock Wheel with High Thermal Performance for Rail Vehicles

(71) Applicant: Bochumer Verein Verkehrstechnik GmbH, Bochum (DE)

(72) Inventors: Andreas Bittner, Hattingen (DE); Franz Murawa, Bochum (DE)

(21) Appl. No.: 19/140,554

(22) PCT Filed: Dec. 12, 2023
(86) PCT No.: PCT/EP2023/085407

§ 371 Date: Jun. 18, 2025

(30) Foreign Application Priority Data
Dec. 22, 2022 (DE) 10 2022 134 548.3

(51) Int. Cl. B60B 17/00

(52) U.S. Cl. CPC B60B 17/0006; B60B 2900/212

(57) ABSTRACT

A monoblock wheel is shown and described with high thermal performance for rail vehicles, with a radial outer wheel rim, a radial inner wheel hub, which is mounted around a centre axle of the monoblock wheel, and a wheel disc which connects the wheel rim to the wheel hub. The wheel rim has a running surface, a flange, an outer side surface in a first plane and an inner side surface in a second plane, wherein the first plane and the second plane run orthogonally to the central axis, wherein the wheel flange has a reference plane running orthogonally to the central axis in the region of its running surface has a running circle diameter, wherein the reference plane relative to the second plane and the inner side surface of the rim is displaced in parallel to the outside by an axial distance, wherein the distance is preferably 50 mm to 80 mm, wherein the wheel rim, the wheel disc and the wheel hub are designed in one piece as a monoblock wheel, and wherein the wheel disc has a median line, the course of which is defined by several design points.

### CROSS-REFERENCE TO RELATED APPLICATIONS

This application is the United States national phase of International Patent Application No. PCT/EP2023/085407 filed Dec. 12, 2023, and claims priority to German Patent Application No. 10 2022 134 548.3 filed Dec. 22, 2022, the disclosures of which are hereby incorporated by reference in their entireties.

### BACKGROUND OF THE INVENTION

### Field of the Invention

The invention relates to a monoblock wheel with high thermal performance capability for rail vehicles, with: a radial outer wheel rim, a radial inner wheel hub running around a centre axis of the solid wheel and a wheel disc, which connects the wheel rim to the wheel hub, wherein the wheel rim has a running surface, a flange, an outer side surface in a first plane and an inner side surface in a second plane, wherein the first plane and the second plane are orthogonal to the central axis, wherein the wheel rim in the region of its running surface has a reference plane running orthogonally to the central axis with a running circle diameter, wherein the reference plane is shifted outwards by an axial distance parallel to the second plane and the inner side surface of the rim, wherein the distance is preferably 50 mm to 80 mm, wherein the wheel rim, the wheel disc and the wheel hub are formed in one piece as a monoblock wheel, and wherein the wheel disc has a median line, the course of which is defined by several design points.

### Description of Related Art

The monoblock wheel according to the invention is a monoblock wheel for rail vehicles, which is particularly suitable for use on the European railway network in accordance with the Technical Specifications for Interoperability TSI WAG (freight waggons) and TSI LOC & PAS (locomotives and passenger cars), the product requirements for which are described in EN 13262 and the requirements required for the approval of such wheels in EN 13979-1.

The main field of application of the object of the invention relates to wheel sets of freight waggons in which braking takes place predominantly with brake pads acting directly on the wheel running surfaces. Due to the friction that occurs, the wheel contact surface is heated up strongly and as a result a strong heat gradient builds up between the wheel hub and wheel rim.

Increasing wheel set loads, higher speeds and the conversion of the brake soles from grey cast iron to composite materials for acoustic reasons lead to ever-increasing thermal loads on the wheels. For example, the K or LL soles made of composite material, which have been legally required in Germany since the end of 2020, have the great advantage over cast iron soles that the wheel running surfaces are not roughened and remain smooth, thus drastically reducing the noise emissions of a passing freight waggon.

However, the disadvantage is the lack of heat dissipation via the brake pads, which occurs with cast iron pads, in other words the entire braking energy is now largely introduced into the wheel rim of the wheel and then primarily dissipated via the wheel rim and wheel disc to the surrounding air.

The braking energies to be taken into account when designing the wheels, which specifically take into account the conditions on the European rail network, are defined by EN 13979-1. For example, monoblock wheels of freight waggons with a running circle diameter of 920 mm are to be designed for 45-minute continuous braking. The total braking energy generated in the normative design is 135 MJ. These braking energies then lead to average wheel rim temperatures of approx. 550° C., while the wheel hubs have only heated up to approx. 50° C. at the end of these braking operations. Due to the temperature, the wheel rim wants to expand, but is prevented from free expansion due to the existing temperature gradients, as the less heated wheel hub hardly expands.

This results in high thermal stresses exceeding the yield strength of the wheel materials used and the resulting plastic deformation portions, which then form macroscopic residual stresses when the wheels cool down. For example, in the case of a rail wheel in monoblock design, tensile stresses act in the wheel disc during continuous braking due to the expanding wheel rim in the radial direction while compressive stresses develop in the wheel rim in the circumferential direction due to the expansion obstruction as a result of the comparatively cold wheel disc. After the braking process is completed, the mechanisms of the heating process are reversed, in other words the wheel rim now wants to contract more strongly, but is prevented from doing so by the previously plasticized and now practically enlarged wheel disc. The result is the formation of tensile residual stresses in the wheel rim in the circumferential direction, while the wheel disc is compressed by the contracting wheel rim. Depending on the design of the wheel disc, this compression process can lead to high local bending stresses and associated axial deformations of the wheel disc. Such axial deformations of the wheel disc, which otherwise also occur in the opposite direction during braking, lead to a change in the axial position of the wheel rim relative to the wheel hub. These are severely restricted by norms, as they lead to changes in the wheel base and track gauge of the wheel sets and thus directly affect the safe track guidance of the wheel set in the track if the limit dimensions are exceeded.

The introductory challenges for the designers of block-brakable monoblock wheels have led to a wide variety of wheel disc shapes, ranging from straight to cup spring-like shapes to a wide variety of wavy shapes with and without camber (camber refers to the offset of the wheel disc between the inlet in the wheel rim and wheel hub). In Europe, as early as 1968, with the introduction of the Y25 bogie by the International Railway Association UIC, its Research and Testing Office (ORE) introduced a standard freight waggon wheel set, which had a corrugated wheel disc without camber and was originally intended to be suitable for 25 t wheel set load. Due to the camber-free wheel disc, the wheel also behaves in a largely stable manner with regard to track gauge during block braking, however, the wheel disc arranged in the measuring circuit plane exhibits a comparatively high radial rigidity despite the waviness and therefore leads to high local stresses in the wheel disc with partial plastifications in addition to a strong expansion impediment of the wheel rim during block braking. This results in high residual tensile stresses in the wheel rim after cooling. Particularly when tread defects such as thermal cracks and similar occur, these residual tensile stresses are highly undesirable, as they can lead to crack progression and ultimately to wheel failure.

Possible improvements to this wheel design led to various solution approaches, which are briefly outlined below.

A wheel set for rail vehicles having a roughly straight wheel disc has been known since the 1970s from the document DE 23 62 434 A1. The track stability of the wheel described therein moves to a further reduced level compared to the UIC standard freight waggon wheel as a result of a balanced load on the wheel disk due to the lack of corrugation. Accordingly, local loads and/or elongation in the wheel disc due to the lack of bending components is at a significantly lower level, but in this wheel the wheel disc is plasticised over the entire thickness from a certain temperature, which, in addition to the impact on the load-bearing capacity for the wheel/rail forces, also has an effect on increased tensile loads of the wheel rim.

A solid wheel for rail vehicles having a bell shape has been known since the 1980s from the document DE 31 17 572 C2. This wheel also has a camber-free wheel disc with a wave that follows a mathematical function, whereby the thickness of the wheel disc has a small and almost constant thickness. In this respect, the radial rigidity of this wheel is significantly reduced compared to the aforementioned wheel versions. However, due to the verification against the mechanical stresses according to the regulations developed in the meantime, the originally intended thin wheel discs can no longer be realised today, which has the effect of higher radial rigidity of the wheel disc and less favourable load and elongation behaviour during pad braking processes.

A wheel disc has been known since the 1990s from document EP 0 798 136 A1, the shape of which corresponds approximately to half a wave of the wheel according to DE 31 17 572 C2, whereby the wave depth is evenly distributed to both sides of the reference plane or measuring circuit plane. The wheel disc therefore has a camber corresponding to the depth of the wave and the wheel disc is oriented towards the flange in the transition to the wheel rim and towards the outer hub end face in the transition to the wheel hub. As a result of the camber of the wheel disc, the radial elasticity is increased in this design compared to the version according to DE 31 17 572 C2, which has a particularly significant effect in further reduced residual stresses in the wheel rim compared to the UIC/ORE wheel. However, the shape of the wheel disc leads to increased axial deflections, especially after the wheels have cooled down, as well as to increased cyclic stresses in the wheel/rail forces occurring during operation.

Document EP 1 225 065 A1 relates to a wheel disc with a wave similar to DE 31 17 572 A1, wherein the maximum of the wave has been shifted so far that it coincides approximately with the plane formed by the outer wheel rim face and the transition from the wheel rim to the wheel disc or from the wheel disc to the wheel hub has been shifted from the reference plane towards the wheel outer side, in other words further below the running surface.

Document EP 1 440 817 A1 describes two wheel modifications which, in principle, are also based on the wave form according to DE 31 17 572 A1, whereby the area of the maximum of the wave is not formed by a curvature but by a straight or flat section (in cross-section). The wheel disc can be designed both free of camber and with a certain camber, wherein the run-in of the wheel disc in the wheel rim and hub is oriented to the reference plane or measuring circuit plane. A distinguishing feature between the two wheel designs described is an angled run-in of the wheel disc in the wheel rim and hub and alternatively a vertical run-in, in other words parallel to the reference plane.

Document EP 2 046 585 B1 describes a freight waggon wheel, the corrugated wheel disc of which moves on both sides of the reference plane by the corrugation pointing towards the outside of the wheel and the inlet of the wheel disc in the hub and wheel rim towards the inside of the wheel. The wave ridge arranged between the wheel rim inner diameter and hub outer diameter is offset towards the wheel rim and the defined radii of the individual areas of the median line of the wheel disc determine their curvature.

In the solution known from document EP 2 801 483 A1, the course of the wheel disc is based on EP 0 798 136 in principle, whereby the radius of the centre line of the wheel disc between the turning point and the transition to the wheel hub is smaller than the radius at the transition to the wheel rim. Furthermore, the distance between the wave in the transition to the wheel rim and the central plane of the waves is greater than the wave in the transition to the wheel hub.

Document EP 3 932 690 A1 also describes two wheel variants, which are basically based on EP 0 798 136 and which differ primarily in the design of the wheel disc run-in in the wheel rim. In the first version, the course of the wheel disc also describes a half wave, whereby the wheel disc on the inside of the wheel can even protrude slightly beyond the inner wheel rim front surface. The entry of the wheel disc into the wheel rim is then released in such a way that this takes place at an angle in the direction of the reference plane of the wheel, while the entry of the wheel disc into the wheel hub should run parallel to the reference plane. Alternatively, a reinforcement is provided below the wheel rim on the side of the tread into which the wheel disc runs in at the aforementioned angle.

Although it must be concluded that the previously described designs already exhibit improvements in thermal behaviour compared to the original wheel known as the UIC/ORE wheel, axial deflections and high thermal stresses still occur depending on the respective design and the amount of brake energy introduced, resulting in residual stresses. These points are overcome by the present invention and a wheel is thus available which is also ideally suited for future increases in wheel set loads and driving speeds while retaining the pad brake.

### SUMMARY OF THE INVENTION

Against this background, the invention is based on the task of further increasing the thermal performance of monoblock wheels beyond the previously achieved state without deteriorating the mechanical properties of the wheel.

This task is solved in the case of a monoblock wheel described at the outset by the following conditions applying to the median line and to the design points, which must be present cumulatively:
a) first design point:
   The first design point is the intersection of a third plane orthogonal to the central axis, which determines the axial position, and a first straight line, which determines the radial position.
   The third plane is offset inwards by an axial distance parallel to the reference plane and runs through the flange area.
   The first straight line passes through a base point at the radial inner and axial outer corner of the rim and is inclined by an angle α between 0° and 14° opposite a second straight line parallel to the central axis.
   The median line of the wheel disc runs parallel to the reference plane in the area of the first design point.
b) second design point:
   The second design point is the vertex of the median line, in other words the outermost axial point on the median line.
   The second design point is the intersection of a fifth plane orthogonal to the central axis that determines the axial position and a diameter that determines the radial position.
   The fifth plane is shifted outwards by an axial distance parallel to the reference plane.
c) Third design point:
   The third design point is the intersection of a fourth plane orthogonal to the central axis that determines the axial position and a diameter that determines the radial position.
   The fourth plane lies between the third plane and the fifth plane and is shifted parallel to these two planes.
d) Fourth design point:
   The fourth design point is a turning point where the curvature direction of the median line changes or a point on a straight line adjacent to the two ends of which the curvature direction of the median line changes.

The invention relates to a monoblock wheel with high thermal performance capability for rail vehicles, with: a radial outer wheel rim, a radial inner wheel hub running around a centre axis of the solid wheel, and a wheel disc, which connects the wheel rim to the wheel hub, wherein the wheel rim has a running surface, a flange, an outer side surface in a first plane and an inner side surface in a second plane, wherein the first plane and the second plane are orthogonal to the central axis, wherein the wheel rim has in the region of its running surface a reference plane running orthogonally to the central axis (also referred to as measuring circle plane) with a running circle diameter, wherein the reference plane is displaced outwards by an axial distance parallel to the second plane and the inner side surface of the rim, wherein the distance is preferably 50 mm to 80 mm, wherein the wheel rim, the wheel disc and the wheel hub are formed in one piece as a monoblock wheel, and wherein the wheel disc has a median line the course of which is defined by a plurality of design points.

According to the invention, it has been recognised that the object according to the invention can be advantageously achieved in a monoblock wheel of this type if the conditions mentioned herein are cumulatively met for the median line and for the design points.

The advantages of the monoblock wheel described are demonstrated in the following assessment during pad braking with a continuous brake output of 50 kW over 45 min with composite brake pads. While in the case of the UIC/ORE wheel with a diameter of 920 mm, the wheel rim can expand by 2.0 mm in the radial direction in relation to the running circle diameter, the radial expansion of the new solid wheel is 3.1 mm and already moves in the direction of a wheel rim which is coupled to the wheel disc by a split connection which does not obstruct the radial expansions of the wheel rim under the temperature influences. With this fictitious solution, the rim could expand radially by 3.9 mm.

As a result, in relation to the UIC/ORE wheel, the residual tensile stresses in the wheel rim do not exceed values of a maximum of approx. 50 N/mm² even in the worn state of the wheel rim after completion of the braking operations, while at the same time maintaining extremely stable track dimensions. At this stress, the associated stress intensity of a possible, reliably detectable crack in the area of the wheel rim is significantly below the threshold value, so that crack growth is prevented if such material damage occurs.

As already mentioned, the second design point is the vertex of the median line, in other words the outermost axial point of the median line. In order to define the axial position of this vertex more precisely and in particular to prevent the wheel disc from protruding axially outwards over the outer side surface of the wheel rim, the following relationships were determined: The axial distance B of the vertex of the median line from the reference plane C should be as follows:

$$B = ( RB - LC ) * 0.3 to 0.9$$

In other words: The reference plane has an axial distance LC to the inner side surface of the rim; the axial distance between the reference plane and the outer side surface of the rim is therefore “RB−LC”. However, the vertex of the median line should be shifted less axially outwards, namely only by 30% to 90% of this distance (0.3 times (RB−LC) to 0.9 times (RB−LC)). In this way, it is ensured that not only the vertex of the median line, but (at least for usual thicknesses of the wheel disc) no point of the wheel disc protrudes axially outwards over the outer side surface of the wheel rim. This has the advantage that the wheel disc does not protrude from the “shadow” of the wheel rim, so that collisions with wheel set bearing housings, trolley frames and the like are prevented.

According to one embodiment of the monoblock wheel, it is provided that the running circle diameter lies in the range between 600 mm and 1250 mm, preferably between 840 mm and 920 mm, particularly preferably running circle diameters in the range of 920 mm. Monoblock wheels with such a tread diameter are particularly suitable for goods transport, where the challenge of improving thermal performance poses in particular due to the use of composite brake soles.

A further design of the monoblock wheel provides that the thickness of the wheel disc adjacent to the wheel hub is greater than the thickness of the wheel disc adjacent to the wheel rim (1), wherein the following preferably applies: 1.05*S1≤S2≤1.95*S1. The wheel disc should therefore taper from the inner wheel hub towards the outer wheel rim. In contrast to a wheel disc with a constant thickness, a wheel disc with a variable thickness has the main advantage of being able to adapt the thickness to the locally existing mechanical requirements. The tapered shape is chosen because the mechanical loads of the wheel result primarily from the lateral force acting on the flange and thus the bending load effective in the wheel disc at the transition from the wheel disc to the wheel hub is at its maximum. In addition, this can reduce the rigidity of the wheel disc in the direction of the wheel rim, which counteracts the thermal expansion capability of the wheel rim and also reduces the wheel weight in the sense of lightweight construction.

The outer part of the wheel disc in the radial direction can be further configured by the wheel disc having a first section between the first design point and the fourth design point which is curved and preferably has a constant curvature throughout. The first section can thus be sectionally or completely curved, in particular circular. Alternatively or in addition to this, the wheel disc may have a second section between the fourth design point and the second design point which is curved and preferably has a constant curvature throughout. The second section can thus also be curved in part or in full, or in particular circular. In a curved configuration of the first and the second section, it may be provided that the first section and the second section have opposite directions of curvature. The opposite curvatures may intersect at a (reversal) point; however, it may also be provided that between the opposite curvatures a straight line running through the fourth design point is provided, which runs parallel to the central axis or at an angle thereto. A straight line may be required for wheels with a particularly large tyre circumference diameter. Opposite curvature directions result in an S-shaped curve with a change from a “left curve” to a “right curve” (or vice versa). A design of this type makes it possible to adjust the radial rigidity as well as the thermal expansion behaviour of the wheel disc in a particularly advantageous manner. Furthermore, with this shape, bending stresses preferably occur in the wheel disc in contrast to dominant normal stress portions in straight wheel disc shapes. This prevents possible full plasticisation of entire wheel disc areas and only partial plasticisation occurs.

The radial inner part of the wheel disc may be further configured in that the wheel disc between the second design point and the third design point has a third section adjoining the second design point and a fourth section adjoining the third design point having opposite curvature directions. Here, too, the aforementioned advantages and properties of opposite curvature directions were recognised and used. To this end, it is further proposed that the third section is curved and preferably has a constant curvature throughout. The third section can also be segmented or completely circular. However, with respect to the fourth section, it is proposed that the fourth section be curved at least in sections and/or be straight at least in sections. The fourth section therefore does not have to be fully curved and in particular does not have a constant curvature; it may even be straight in sections, in particular in the region adjoining the wheel hub, in other words in the “entry” into the wheel hub. This allows the transition between the wheel disc and wheel hub to be designed in the desired manner. In the area of the wheel hub, the highest possible radial rigidity is desired in order to achieve a sufficiently “firm” adhesive connection between the wheel and the shaft. In this respect, more inclined wheel disc curves running into the wheel hub, for example, are counterproductive.

According to a further embodiment of the monoblock wheel, it is provided that the wheel rim between the base point and the transition into the first section of the wheel disc has an inner lateral surface that runs partially or completely along the first straight lines. A largely straight course of the inner lateral surface is particularly easy to produce and offers a particularly high thermal and mechanical load capacity, which is advantageous for use in heavy-duty freight transport, for example, due to the high wheel set loads that occur there.

According to an alternative embodiment of the monoblock wheel, it is provided that the wheel rim between the base point and the transition into the first section of the wheel disc has an inner lateral surface which has an undercut, which preferably has a radial depth of at least 3 mm. A weight reduction, in other words a lightweight variant of the monoblock wheel, can be achieved by means of a radially outwardly convex, ring-shaped circumferential undercut (in the direction of the tread). This has advantages in the field of passenger train traffic, where rather low wheel set loads occur, but there are special requirements for lightweight construction and noise damping, especially for high-speed trains. The weight-saving potential of such undercutting depends on the wheel dimensions and the specified wheel set loads. For example, in the case of a monoblock wheel with a tyre circumference diameter of 920 mm at a wheel set load of 20 t, the wheel weight in new condition can be reduced by up to approx. 15 kg or by approx. 4%.

In relation to this embodiment of the monoblock wheel, it is further proposed that the undercut has several sections, in particular a first radius, a second radius and a third straight line arranged in between. The radii allow uniform transitions to be achieved at both ends of the undercut, which leads to an optimised stress curve (reduced notch effect).

Finally, according to a further embodiment of the monoblock wheel, it is provided that the inner lateral surface has an approach with an axial width, wherein the following preferably applies: RB1=(0.15 to 0.5)*(RB−LC). In addition to the undercut (in particular alongside the undercut), a stiffening approach with increased material thickness compared to the undercut is also provided to ensure sufficiently good mechanical properties. The approach increases the resistance moment of the wheel rim in particular, which has a stress-reducing effect, especially in the case of wheel forces in the outer tread area and/or in the case of lateral forces that act in the direction of the wheel back (for example when driving over switches). In addition, the attachment, in particular if it is cylindrical, can facilitate the attachment of sound-damping devices or absorbers. Due to the greater material thickness of the attachment compared to the undercut, noise damping devices or absorbers mounted there can even be designed to be particularly wide and protrude beyond the width of the attachment beyond the undercut. This allows the use of particularly powerful sound-damping devices or absorbers.

### BRIEF DESCRIPTION OF THE DRAWINGS

The invention is explained in more detail below by means of a drawing which only represents a preferred embodiment in which:

FIG. 1: is a first embodiment of a monoblock wheel according to the invention in a sectional view,

FIG. 2: is a second embodiment of a monoblock wheel according to the invention in a sectional view,

### DESCRIPTION OF THE INVENTION

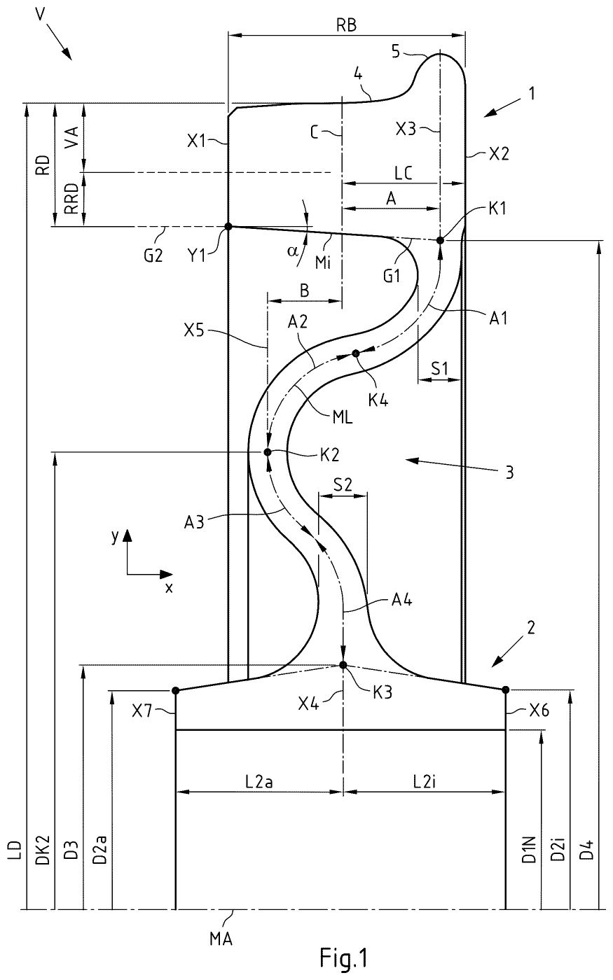

FIG. 1 is a first embodiment of a monoblock wheel V according to the invention in a sectional view. The monoblock wheel V initially has a radial outer wheel rim 1. The radial direction is shown in FIG. 1 characterised by the coordinate y (represented as an arrow), wherein the positive y-direction is oriented radially outwards, while the negative y-direction is oriented radially inwards (in other words in the direction of a wheel centre axis MA). On the other hand, the coordinate x (also represented as an arrow) denotes the axial direction, whereby the positive x-direction is axially oriented inwards (in other words in the direction of the centre of the gear set or in the direction of the opposite solid wheel), while the negative x-direction is axially oriented outwards.

The monoblock wheel V also has a radial inner wheel hub 2 as well as a wheel disc 3, which connects the wheel rim 1 with the wheel hub 2. The wheel rim 1 has a running surface 4 and a flange 5. The running surface 4 runs on the rail and can also serve as a braking surface for a friction brake. The flange 5, on the other hand, is used to transfer axial wheel guidance forces. The wheel rim 1, the wheel disc 3 and the wheel hub 2 are designed as a single piece, which is why wheels of this type, unlike multi-part wheels, are also referred to as “solid wheels” or “monoblock wheels”. The wheel disc 3 has a median line ML, the course of which is defined by several design points K1, K2, K2, K4.

The wheel rim 1 has an axial outer side surface in a first plane X1 and an axial inner side surface in a second plane X2. Between the outer side surface (or the first plane X1) and the inner side surface (or the second plane X2) of the wheel rim 1 is a reference plane C of the solid wheel V defined as a measuring circuit plane. In the reference plane C, a running circuit diameter LD is measured. In addition, the reference plane C serves as a starting point for different wheel profiles, which apply depending on the norm or standard to be applied. These norms and standards are used to derive the cross-sectional dimensions of the wheel set that are decisive for safe track guidance in the rail network. For example, between the inner lateral surface (or the second plane X2) of the wheel rim 1 and the reference plane C a distance LC is created, which may be, for example, 70 mm (technical specification for the interoperability of the rail system in the European Union for the rolling stock—freight waggons as well as locomotives and passenger cars subsystems—uniform for the track gauges 1435, 1524, 1600 and 1668 mm). For tracks outside this operating group, the standards applicable there must be applied. The wheel rim 1 has a radial thickness RD, which is composed of a wear portion FA and the remaining wheel rim thickness RRD, which must not be fallen below during operation for reasons of strength (RD=VA+RDD). The wheel rim 1 also has an axial width RB, which is preferably in the range between 120 mm and 150 mm and can in particular be 135 mm.

The wheel hub 2 provides the secure connection of the monoblock wheel V with the (in FIG. 1 not shown) gear set shaft. It is usually pressed onto a shaft seat with an excess of cold or shrunk on warm. The wheel hub 2 has a bore diameter D1N, which is determined by the fatigue strength verification for the shaft seat, which results from the applicable standards in Europe in accordance with EN 13103-1. The excess dimension between wheel hub 2 and shaft seat depends on the occurring loads of the wheel set such as braking torques, short-circuit torques, the lateral forces between wheel and rail, the process parameters during assembly and the temperature gradients within the wheel as well as between wheel and shaft and is preferably between 0.75‰ and 2.5‰.

The wheel hub 2 has an axial outer hub diameter D2a and an axial inner hub diameter D2i. The following applies here:

$$1.14 * D 1 N \leq D 2 a or D 2 i \leq 1.55 * D 1 N .$$

The entry of the median line ML of the wheel disc 3 into the wheel rim 1 runs parallel to the reference plane C in a third plane X3 intended for this purpose in the axial distance A. This third plane X3 must be determined such that the entire thickness S1 of the wheel disk 3 is located in the area of the entry into the wheel rim 1 within the area of the flange 5 (this should in any case apply to a wheel with a flange in new condition). The intersection point of this third plane X3 with the wheel rim inner diameter D4 results in the first design point K1 of the wheel disc 3. In this case, the wheel rim inner diameter D4 results from a base point Y1 of the wheel rim 1 and a first straight line G1, which runs at an angle α between 0° and 14° (inwards) to a second straight line G2 running axially (in other words parallel to the wheel centre axis MA). The wheel rim 1 has an inner lateral surface Mi which, in the first configuration of the solid wheel V (FIG. 1) runs almost completely along the first straight line G1.

With its median line ML, the wheel disc 3 running from the first design point K1 in the direction of the wheel hub 2 describes a “wavelength” which is oriented outwards in the axial direction. This wave peak begins, starting at the wheel rim 1, with a curved (for example circular) first section A1 rising up to the fourth design point K4 (which mathematically represents a “reversal point” at which the curvature direction changes; alternatively, the fourth design point can be part of a straight line whose both ends adjoin opposite curvatures) followed by a curved (for example circular) flattening second section A2 with the second design point K2 as the vertex of the wave crest. This is followed further in the direction of the wheel hub 2 by a curved (for example circular) descending third section A3 and an in any case sectionally curved flattening fourth section A4 with a tangential transition to a fourth plane X4 running parallel to the reference plane C with the third design point K3 as the end point of the wheel disc 3, through which the entry into the wheel hub 2 is defined.

The third design point K3 is an intersection point with a hub diameter D3, which is formed according to the relationship:

$$D 3 = maximum value ( D 2 a , D 2 i ) + minimum value ( L 2 a , L 2 i ) * 0.15 to 0.6$$

In this case, L2a corresponds to the axial distance between a (axially outer) hub outer end face in a seventh plane X7 and the fourth plane X4 and L2i corresponds to the axial distance between a (axially inner) hub inner end face in a sixth plane X6 and the fourth plane X4. The distance of the fourth plane X4 lies in the x-direction preferably between the third plane X3 (first design point K1) and the fifth plane X5 (second design point K2).

The second design point K2 of the wheel disc 3 is formed from the intersection between the second design point K2 of the median line ML and the fifth plane X5 running parallel to the reference plane C, wherein:

$$DK 2 = 0.35 to 0.6 * ( D 4 - D 3 ) + D 3$$

The axial distance B of this fifth plane X5 from the reference plane C is as follows:

$$B = ( RB - LC ) * 0.3 to 0.9$$

The thickness of the wheel disc 3 is determined on the basis of numerical verification calculations and, in addition to the thermal loads, must also take into account the cyclic loads due to the wheel/rail forces. This circumstance is taken into account in that the course of the wheel disc 3 is designed to be tapered in the direction of the wheel rim 1 according to the median line ML between the design points K3 and K4, wherein the following applies to the ratio of the thickness S1 (adjacent to the wheel rim 1) and the thickness S2 (adjacent to the wheel hub 2):

$$1.05 * S 1 \leq S 2 \leq 1.95 * S 1$$

The transition from the wheel disc 3 to the wheel hub 2 and from the wheel disc 3 to the wheel rim 1 takes place tangentially by means of radii or elliptical transitions connecting the wheel hub outer surfaces or wheel rim inner surfaces to the wheel disc.

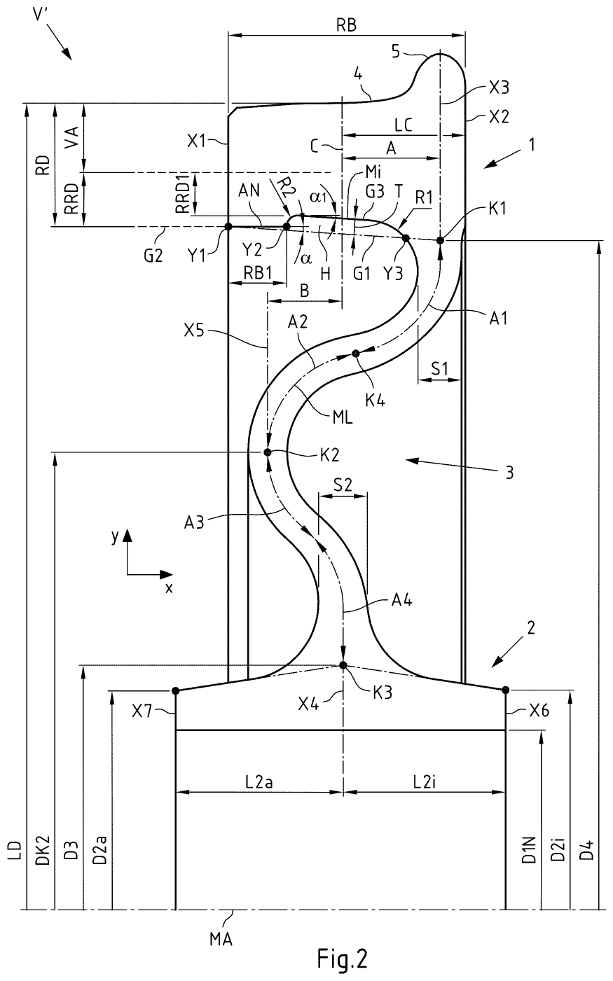

FIG. 2 shows a second embodiment of a monoblock wheel V′ according to the invention in a sectional view. The reference marks already used in connection with FIG. 1 are used accordingly in FIG. 2. The main difference between the second embodiment (shown in FIG. 2) of the monoblock wheel V′ and the first embodiment (shown in FIG. 1) of the monoblock wheel V lies in the design of the radially inner side of the wheel rim 1, in particular in the course of the inner lateral surface Mi. The inner lateral surface Mi extends from the base point Y1 to the transition into the first section A1 of the wheel disc 3.

In contrast to the first embodiment of the monoblock wheel V (FIG. 1) in which the inner lateral surface Mi runs almost entirely along the first straight line G1, in the second embodiment of the monoblock wheel V′ (FIG. 2) the inner lateral surface Mi shows an attachment AN and an undercut H.

The attachment AN extends from the base point Y1 in the axial direction to an outer second base point Y2 and has an axial width RB1. The attachment AN can (as shown in FIG. 2) run along the straight line G2, in other words parallel to the wheel centre axis MA. This results in a cylindrical form of the attachment AN, which can simplify the attachment of sound absorption systems or absorbers, for example. Alternatively (and differently from that shown FIG. 2), the attachment AN can also run at an incline, for example along the first straight line G1, which runs at an angle α between 0° and 14° (inwards) to the second straight line G2 running axially (in other words in parallel to the wheel centre axis MA).

The undercut H extends from the outer second footpoint Y2 to an inner third footpoint Y3. Starting from the straight line G1, the undercut H has a radial depth T (measured orthogonally to the straight line G1). The undercut H may comprise several different sections, for example a first radius R1 (adjacent to the third footpoint Y3, formed by the intersection point of the first radius R1 with the first straight line G1), a second radius R2 (adjacent to the second footpoint Y2) and a third straight line G3 arranged in between. Alternatively (and differently from that shown in FIG. 2), an ellipse or a basket arc can also be arranged between the first radius R1 and the second radius R2. The third straight line G3 can run at an angle α1 between 0° and 14° (inwards) to the second straight line G2 running axially (in other words in parallel to the wheel centre axis MA).

The shape of the undercut H curving in an outward radial direction (in the direction of the running surface 4) achieves a weight reduction, whereby a reduced residual wheel rim thickness RRD1 is obtained, which preferably is at least 12 mm. Sufficient rigidity is ensured in particular by the attachment AN. The monoblock wheel V′ shown in FIG. 2 is therefore a lightweight variant of the monoblock wheel V shown in FIG. 1.

### LIST OF REFERENCE NUMERALS

1: Wheel rim
2: Wheel hub
3: Wheel disc
4: Running surface
5: Flange
A: Axial distance (between reference plane C and third plane X3)
A1: First section (of the median line ML/of the wheel disc 3)
A2: Second section (of the median line ML/of the wheel disc 3)
A3: Third section (of the median line ML/of the wheel disc 3)
A4: Fourth section (of the ML median line/wheel disc 3)
AN: Attachment
C: Reference plane (of the monoblock wheel V, V′)
D1N: Bore diameter (of wheel hub 2)
D2a: External hub outer diameter
D2i: Inner hub outer diameter
D3: Hub diameter (of design point K3)
D4: Flange inner diameter
G1: First straight line
G2: Second straight line
G3: Third straight line
13: Undercut
K1: First design point
K2: Second design point
K3: Third design point
K4: Fourth design point
L2a: Distance (fourth plane X4-seventh plane X7)
L2i: Distance (fourth plane X4-sixth plane X6)
LC: Axial distance (between reference plane C and inner side surface X2)
LD: Running circle diameter
MA: Centre axle (of solid wheel V, V′)
Mi: Inner lateral surface (of wheel rim 1)
ML: Median line (of wheel disk 3)
R1: First radius (of undercut H)
R2: Second radius (of undercut H)
RB: Wheel rim width (axial)
RB1: Axial width (of the AN approach)
RD: Rim thickness (radial)
RRD: Residual rim thickness (radial)
RRD1: Reduced residual rim thickness (radial)
S1: Thickness of wheel disc 3 (adjacent to wheel rim 1)
S2: Thickness of wheel disk 3 (adjacent to wheel hub 2)
T: Depth (of undercut H)
V, V′: Monoblock wheel
FA: Wear part
X: Axial direction
X1: First plane (axially outer side surface of wheel rim 1)
X2: Second plane (axially inner side surface of wheel rim 1)
X3 Third plane (entry level median line ML in wheel rim 1)
X4: Fourth plane (entry level median line ML in wheel hub 2)
X5: Fifth plane (vertex plane)
X6: Sixth plane (hub inner end face)
X7: Seventh plane (hub outer end face)
y: Radial direction
Y1: Base point (of rim 1)
Y2: Second base point (of rim 1)
Y3: Third base point (of rim 1)
α: Angle (of the straight G1)
α1: Angle (of the straight G3)

1. A monoblock wheel with high thermal performance for rail vehicles, with:
a radial outer wheel rim,
a radial inner wheel hub, which runs around a central axis of the monoblock wheel, and
a wheel disc which connects the wheel rim to the wheel hub,
wherein the wheel rim has a running surface, a flange, an outer side surface in a first plane and an inner side surface in a second plane,
wherein the first plane and the second plane are orthogonal to the central axis,
wherein the wheel rim has a reference plane running orthogonally to the central axis with a running circle diameter in the region of its running surface,
wherein the reference plane relative to the second plane and the inner lateral surface of the rim ring is shifted outwards in parallel by an axial distance, wherein the distance is preferably 50 mm to 80 mm,
wherein the wheel rim, the wheel disc and the wheel hub are designed in one piece as a monoblock wheel, and
wherein the wheel disc has a median line the course of which is defined by a plurality of design points,
wherein
for the median line and for the design points, the following conditions apply:
a) First design point:
The first design point is the intersection of a third plane orthogonal to the centre axis that determines the axial position and a first straight line that determines the radial position.
The third plane is displaced inward parallel to the reference plane by an axial distance and runs through the flange area.
The first straight line passes through a base point at the radial inner and axial outer corner of the rim and is opposite a second straight line parallel to the centre axis at an angle between 0° and 14°.
The median line of the wheel disc runs parallel to the reference plane in the area of the first design point.
b) Second design point:
The second design point is the vertex of the median line, in other words the outermost axial point of the median line.
The second design point is the intersection of a fifth plane orthogonal to the central axis that determines the axial position and a diameter that determines the radial position.
The fifth plane is shifted outwards parallel to the reference plane by an axial distance.
c) Third design point:
The third design point is the intersection of a fourth plane orthogonal to the centre axis that determines the axial position and a diameter that determines the radial position.
The fourth plane lies between the third plane and the fifth plane and is shifted parallel to these two planes.
d) Fourth design point:
The fourth design point (is a turning point at which the curvature direction of the median line changes or a point on a straight line adjacent to the two ends of which the curvature direction of the median line changes.

2. The monoblock wheel according to claim 1,
wherein
the running circle diameter is in the range between 600 mm and 1250 mm, preferably between 840 mm and 920 mm.

3. The monoblock wheel according to claim 1,
wherein
the thickness of the wheel disc adjacent to the wheel hub is greater than the thickness of the wheel disc adjacent to the wheel rim, wherein the following preferably applies: 1.05*S1≤S2≤1.95*S1.

4. The monoblock wheel according to claim 1,
wherein
the wheel disc has a first section between the first design point and the fourth design point which is curved and preferably has a constant curvature throughout.

5. The monoblock wheel according to claim 1,
wherein
the wheel disc between the fourth design point and the second design point has a second section which is curved and preferably has a constant curvature throughout.

6. The monoblock wheel according to claim 4,
wherein
the first section and the second section have opposite curvature directions.

7. The monoblock wheel according to claim 1,
wherein
the wheel disc between the second design point and the third design point has a third section adjoining the second design point and a fourth section adjoining the third design point having opposite curvature directions.

8. The monoblock wheel according to claim 7,
wherein
the third section is curved and preferably has a constant curvature throughout.

9. The monoblock wheel according to claim 7,
wherein
the fourth section is curved at least in sections and/or is straight at least in sections.

10. The monoblock wheel according to claim 1,
wherein
the wheel rim between the base point and the transition into the first section of the wheel disc has an inner lateral surface that runs partially or completely along the first straight lines.

11. The monoblock wheel according to claim 1,
wherein
the wheel rim between the base point and the transition into the first section of the wheel disc has an inner lateral surface which has an undercut which preferably has a radial depth of at least 3 mm.

12. The monoblock wheel according to claim 11,
wherein
the undercut has several sections, in particular a first radius, a second radius and a third straight line arranged therebetween.

13. The monoblock wheel according to claim 11,
wherein
the inner lateral surface has an attachment with an axial width, wherein preferably: RB1=(0.15 to 0.5)*(RB−LC).
